(19) United States
(12) Patent Application Publication
(10) Pub. No.: US 2010/0245396 A1
(43) Pub. Date: Sep. 30, 2010

(54) DISPLAY APPARATUS AND DRIVING METHOD THEREOF

(75) Inventors: Yi-Pai Huang, Chiayi City (TW); Han-Ping D. Shieh, Hsinchu City (TW); Ching-Ming Wei, Taichung City (TW); Chi-Chung Tsai, Kinmen County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/468,044

(22) Filed: May 18, 2009

(30) Foreign Application Priority Data
Mar. 26, 2009 (TW) 98110008

(51) Int. Cl. G09G 5/10; G09G 3/36

(52) U.S. Cl. 345/690; 345/88; 345/102

(57) ABSTRACT

A display apparatus and driving method thereof are provided. The driving method is adapted for driving a backlight module and a display panel thereon, and includes at least the following steps. Firstly, a backlight data and a display data are outputted according to a color distribution of an expected image. Afterwards, a light-emitting pattern whose color distribution corresponds to the color distribution of the expected image of the backlight module is determined according to the backlight data. Besides, a display pattern of the display panel is determined according to the display data. The expected image is displayed through the light-emitting pattern and the display pattern.

### CROSS-REFERENCE TO RELATED APPLICATION

This application claims the priority benefit of Taiwan application serial no. 98110008, filed on Mar. 26, 2009. The entirety of the above-mentioned patent application is hereby incorporated by reference herein and made a part of specification.

### BACKGROUND OF THE INVENTION

1. Field of the Invention

The present invention relates to an apparatus and a driving method thereof, and more particularly to a display apparatus and a driving method thereof.

2. Description of Related Art

With development of optoelectronic and semiconductor techniques, display apparatuses are developed accordingly, in which liquid crystal display (LCD) apparatuses become popular in the market due to features of high space utilization efficiency, free of radiation, and low electromagnetic interference etc.

Since the display panel in the LCD apparatus has no luminescent function itself, the backlight module is usually disposed beneath the display panel for providing a planar light source required by the display panel. The display panel determines the transmittance of the planar light source of the backlight module through the liquid crystal (LC) molecules in the LC layer for the LCD apparatus to display images to the users.

However, when the LC molecules in the LC layer of the display panel are arranged poorly, light leakage occurs in dark images, thereby reducing the contrast ratio and color saturation of the display image. To solve the aforementioned problem, an LCD apparatus with a local controlled backlight module is provided.

In light of the foregoing, the light-emitting unit in the local controlled backlight module emits light based on the profile of the expected image. For example, the expected image is a scene of an evening sky along with a moon. Consequently, the light-emitting units corresponding to the moon provide white light source and the light-emitting units corresponding to the evening sky do not provide any light source. In other words, the light-emitting pattern provided by the light-emitting units is similar to the expected image.

Through the design aforementioned, the contrast ratio of the moon (white) and the evening sky (black) is enhanced. However, such local controlled backlight module merely improves the contrast ratio of the display image, and does not enhance the color saturation of the display image.

### SUMMARY OF THE INVENTION

The present invention provides a display apparatus, where a display image thereof has high color saturation and contrast ratio.

The present invention provides another display apparatus, which has the advantage of low power consumption.

The present invention further provides a driving method adapted for driving a display apparatus and configured to enhance the color saturation of a display image.

The present invention provides a driving method adapted for driving a backlight module and a display panel thereon. The driving method includes the following steps. Firstly, a backlight data and a display data are outputted according to a color distribution of an expected image. Next, a light-emitting pattern of the backlight module is determined according to the backlight data. Here, a color distribution of the light-emitting pattern corresponds to the color distribution of the expected image. On the other hand, a display pattern of the display panel is determined according to the display data.

The present invention provides a display apparatus including a backlight module, a display panel, and a controller. The display panel is disposed on the backlight module and the controller is coupled to the backlight module and the display panel. Moreover, the controller outputs a backlight data to the backlight module according to a color distribution of an expected image and determines a light-emitting pattern of the backlight module according to the backlight data. A color distribution of the light-emitting pattern corresponds to the color distribution of the expected image. On the other hand, the controller outputs a display data to the display panel according to the color distribution of the expected image and determines a display pattern of the display panel according to the display data.

According to an embodiment of the driving method and the display apparatus provided in the present invention, the controller generates and outputs the backlight data according to the color distribution of the expected image. The controller further generates and outputs the display data according to the color distribution of the expected image and the backlight data.

According to an embodiment of the display apparatus in the present invention, the display panel includes a passive LCD panel.

According to an embodiment of the driving method and the display apparatus in the present invention, the light-emitting pattern has a first color region, a second color region, a third color region, and a fourth color region. The color distributions of the first color region, the second color region, the third color region, and the fourth color region correspond to the color distribution of the expected image. In one embodiment, the display data has a first sub-display data recording a specific gray-scale value, a second sub-display data recording a first color gray-scale value, a third sub-display data recording a second color gray-scale value, and a fourth sub-display data recording a third color gray-scale value. Moreover, the display pattern has a first gray-scale pattern, a second gray-scale pattern, a third gray-scale pattern, and a fourth gray-scale pattern. According to an embodiment, a first initial color gray-scale value, a second initial color gray-scale value, and a third initial color gray-scale value are recorded in the display data. The specific gray-scale value is the minimum value of the first initial color gray-scale value, the second initial color gray-scale value, and the third initial color gray-scale value. In addition, the first color gray-scale value is the difference between the first initial color gray-scale value and the specific gray-scale value. The second color gray-scale value is the difference between the second initial color gray-scale value and the specific gray-scale value. Additionally, the third color gray-scale value is the difference between the third initial color gray-scale value and the specific gray-scale value.

According to an embodiment of the driving method and the display apparatus of the present invention, the controller determines the first gray-scale pattern, the second gray-scale pattern, the third gray-scale pattern, and the fourth gray-scale pattern according to the first sub-display data, the second sub-display data, the third sub-display data, and the fourth sub-display data respectively, so as to determine the display pattern of the display panel aforementioned.

According to an embodiment of the driving method and the display apparatus of the present invention, the expected image has a first sub-image, a second sub-image, a third sub-image, and a fourth sub-image. The step of displaying the expected image includes the following sub-steps. Firstly, the display apparatus displays the first sub-image according to the first color region and the first gray-scale pattern. Then, the display apparatus displays the second sub-image according to the second color region and the second gray-scale pattern. Next, the display apparatus displays the third sub-image according to the third color region and the third gray-scale pattern. Afterwards, the display apparatus displays the fourth sub-image according to the fourth color region and the fourth gray-scale pattern. In other words, the first sub-image, the second sub-image, the third sub-image, and the fourth sub-image are displayed sequentially. In one embodiment, the color of the first color region includes red, green, and blue, the second color region is a red region, the third color region is a green region, and the fourth color region is a blue region.

According to an embodiment of the display apparatus of the present invention, the backlight module includes a plurality of first color light-emitting units, a plurality of second color light-emitting units, and a plurality of third color light-emitting units. Here, at least a portion of the first color light-emitting units, at least a portion of the second color light-emitting units, and at least a portion of the third color light-emitting units provide the first color region. Moreover, at least a portion of the first color light-emitting units provides the second color region, at least a portion of the second color light-emitting units provides the third color region, and at least a portion of the third color light-emitting units provides the fourth color region.

According to an embodiment of the driving method and the display apparatus in the present invention, the light-emitting pattern has a first color region, a second color region, and a third color region. The color distributions of the first color region, the second color region, and the third color region correspond to the color distribution of the expected image. In one embodiment, the display data has a first sub-display data recording a first color gray-scale value, a second sub-display data recording a second color gray-scale value, and a third sub-display data recording a third color gray-scale value. In addition, the display pattern has a first gray-scale pattern, a second gray-scale pattern, and a third gray-scale pattern.

According to an embodiment of the driving method and the display apparatus of the present invention, the controller determines the first gray-scale pattern, the second gray-scale pattern, and the third gray-scale pattern according to the first sub-display data, the second sub-display data, and the third sub-display data respectively, so as to determine the display pattern of the display panel aforementioned.

According to an embodiment of the driving method and the display apparatus of the present invention, the expected image has a first sub-image, a second sub-image, and a third sub-image. The step of displaying the expected image includes the following sub-steps. Firstly, the display apparatus displays the first sub-image according to the first color region and the first gray-scale pattern. Next, the display apparatus displays the second sub-image according to the second color region and the second gray-scale pattern. Thereafter, the display apparatus displays the third sub-image according to the third color region and the third gray-scale pattern. In other words, the first sub-image, the second sub-image, and the third sub-image are displayed sequentially.

According to an embodiment of the display apparatus of the present invention, the backlight module includes a plurality of first color light-emitting units, a plurality of second color light-emitting units, and a plurality of third color light-emitting units. Moreover, at least a portion of the first color light-emitting units provides the first color region, at least a portion of the second color light-emitting units provides the second color region, and at least a portion of the third color light-emitting units provides the third color region.

According to an embodiment of the driving method and the display apparatus of the present invention, the light-emitting pattern and the display pattern are a multicolored region and a multicolored pattern respectively. A color distribution of the multicolored region and a color distribution of the multicolored pattern correspond to the color distribution of the expected image respectively.

According to an embodiment of the display apparatus of the present invention, the backlight module includes a plurality of first color light-emitting units, a plurality of second color light-emitting units, and a plurality of third color light-emitting units. Here, at least a portion of the first color light-emitting units, at least a portion of the second color light-emitting units, and at least a portion of the third color light-emitting units provide the multicolored region. Furthermore, the display panel includes a color filter.

In light of the foregoing, the backlight module in the display apparatus of the present invention provides the light-emitting pattern that corresponds to the color distribution of the expected image. Therefore, not only the power consumption of the backlight module is reduced, but the color saturation of the display image of the display apparatus is also enhanced. Hence, the contrast ratio and the color saturation are greatly enhanced in the display image of the display apparatus applying the driving method of the present invention.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a framework of a display apparatus according to an embodiment of the present invention.

FIG. 2 is a partial cross-sectional view of a display apparatus according to an embodiment of the present invention.

FIG. 3 is a flow chart illustrating a driving method according to an embodiment of the present invention.

FIG. 4A is a schematic diagram of an expected image, a backlight data, and a display data according to an embodiment of the present invention.

FIG. 4B is a schematic diagram of a backlight data and a light-emitting pattern according to a first embodiment of the present invention.

FIG. 4C is a schematic diagram of a display data and a display pattern according to the first embodiment of the present invention.

FIG. 5A is a schematic diagram of a backlight data and a light-emitting pattern according to a second embodiment of the present invention.

FIG. 5B is a schematic diagram of a display data and a display pattern according to the second embodiment of the present invention.

FIG. 6 is a partial cross-sectional view of a display panel according to a third embodiment of the present invention.

FIG. 7A is a schematic diagram of a backlight data and a light-emitting pattern according to the third embodiment of the present invention.

FIG. 7B is a schematic diagram of a display data and a display pattern according to the third embodiment of the present invention.

### DESCRIPTION OF EMBODIMENTS

### First Embodiment

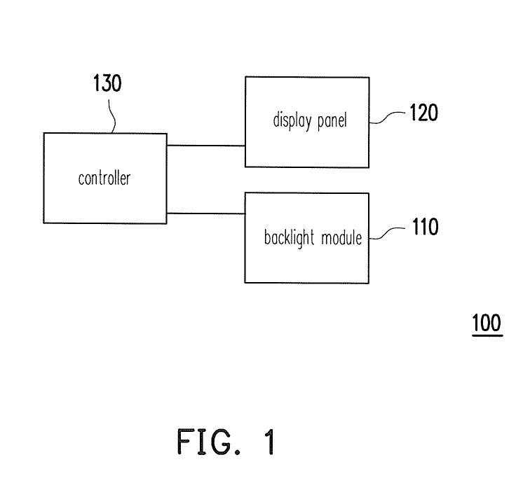

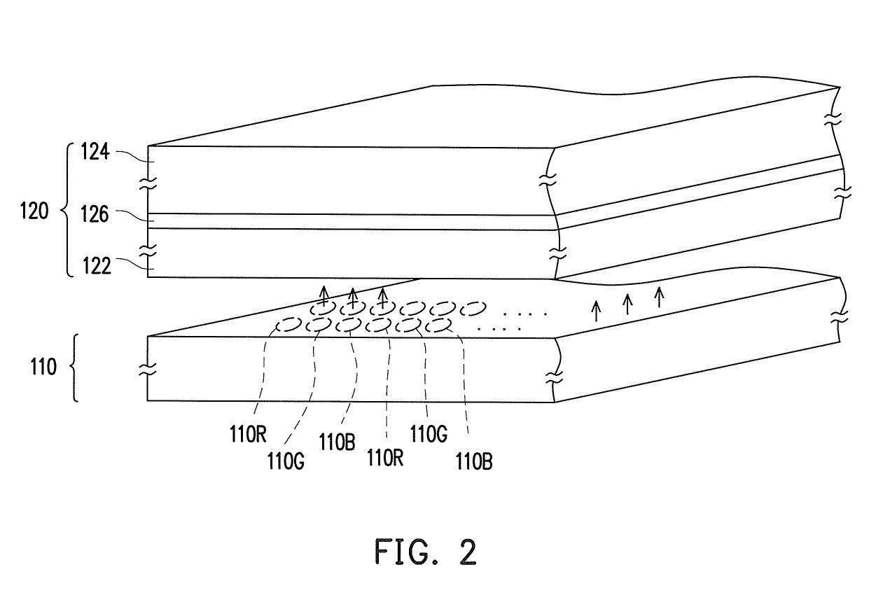

FIG. 1 is a schematic view illustrating a framework of a display apparatus according to an embodiment of the present invention. FIG. 2 is a partial cross-sectional view of a display apparatus according to an embodiment of the present invention. Here, FIG. 2 merely shows a backlight module 110 and a display panel 120. Referring to FIG. 1 and FIG. 2 simultaneously, a display apparatus 100 of the present embodiment includes a backlight module 110, a display panel 120, and a controller 130. The controller 130 is coupled to the backlight module 110 and the display panel 120. The display panel 120 is disposed on the backlight module 110. Moreover, the display panel 120 is assembled by clamping an LC layer 126 between two substrates 122 and 124. Obviously, the display apparatus 100 of the present embodiment can further include other components, and FIG. 1 and FIG. 2 omit the other components mainly to facilitate the illustration of the following embodiment.

In the present embodiment, the display panel 120 is a passive LCD panel, for example. The substrates 122, 124 and the LC layer 126 are respectively a passive array substrate, an opposite substrate, and a super twisted nematic liquid crystal (STN LC) layer, for instance. However, in other embodiments, the display panel 120 can also be an active LCD panel or display panels of other types. In other words, the present invention does not limit the type of the display panel 120.

On the other hand, the backlight module 110 of the present embodiment is, for example, a local controlled backlight module. The local controlled backlight module noted here is the backlight module 110 that provides a multicolored light-emitting pattern (described in the following). Here, the color distribution of this multicolored light-emitting pattern corresponds to the color distribution of the expected image. That is, the backlight module 110 provides a multicolored light-emitting pattern which is similar to the expected image. Moreover, the light-emitting intensity of the backlight module 110 alters with the brightness of the expected image. Thus, not only the overall gray-scale number of the display image of the display apparatus 100 is increased, but the power consumption of the display apparatus 100 is also reduced.

As aforementioned, the backlight module 110 of the present embodiment includes a plurality of first color light-emitting units 110R, a plurality of second color light-emitting units 110G, and a plurality of third color light-emitting units 110B to further provide various light-emitting patterns, such as red-light pattern, green-light pattern, blue-light pattern, multicolored-light pattern, and the like. In the following embodiment, the first, the second, and the third color light-emitting units 110R, 110G, and 110B are assumed to be red, green, and blue light-emitting units respectively. Furthermore, these red, green, and blue light-emitting units are arranged alternately as an array.

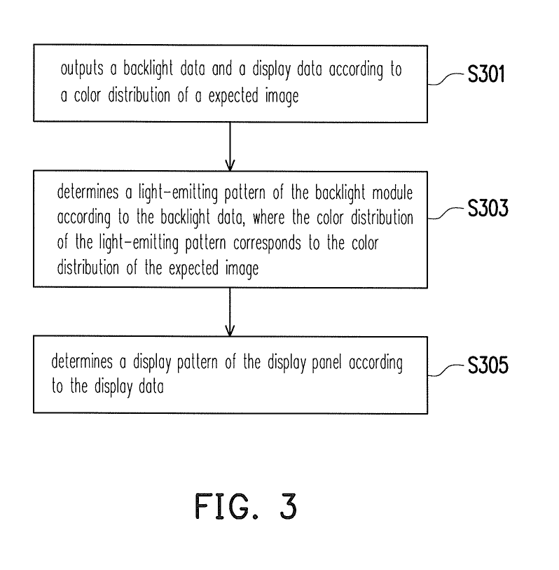

FIG. 3 is a flow chart illustrating a driving method according to an embodiment of the present invention. Referring to FIG. 1, FIG. 2, and FIG. 3 simultaneously, firstly, the controller 130 outputs a backlight data and a display data according to the color distribution of an expected image 400 (step S301).

It should be noted that the aforementioned display data is generated from the color distribution of the expected image and the backlight data. In details, the controller 130 of the present embodiment generates the backlight data according to the color distribution of the expected image and then generates the display data according to the color distribution of the expected image and this backlight data.

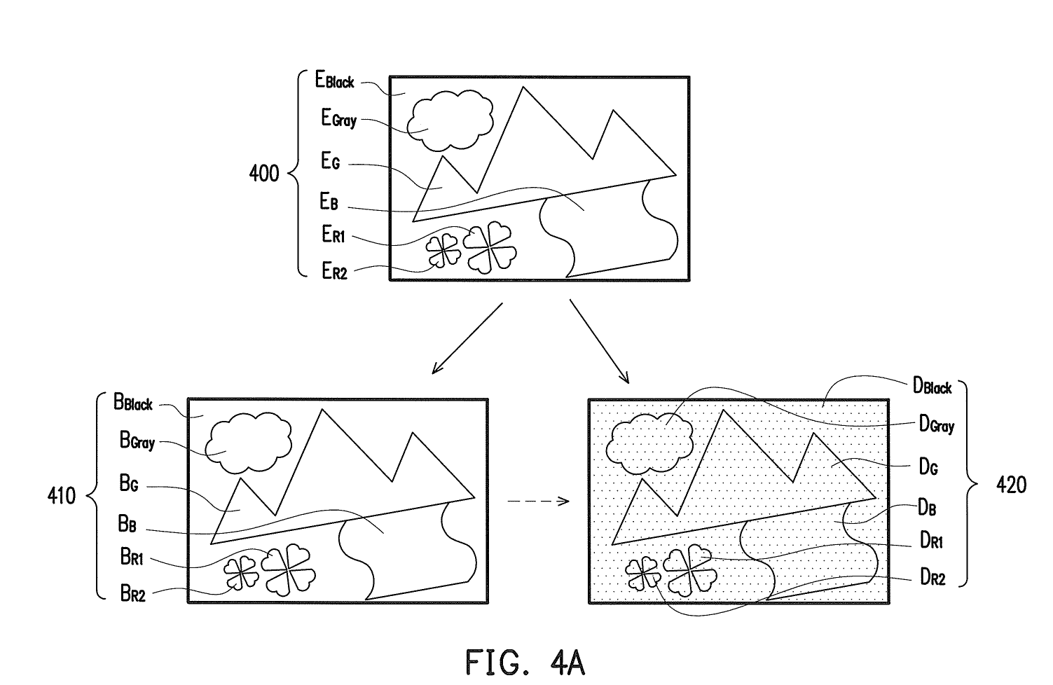

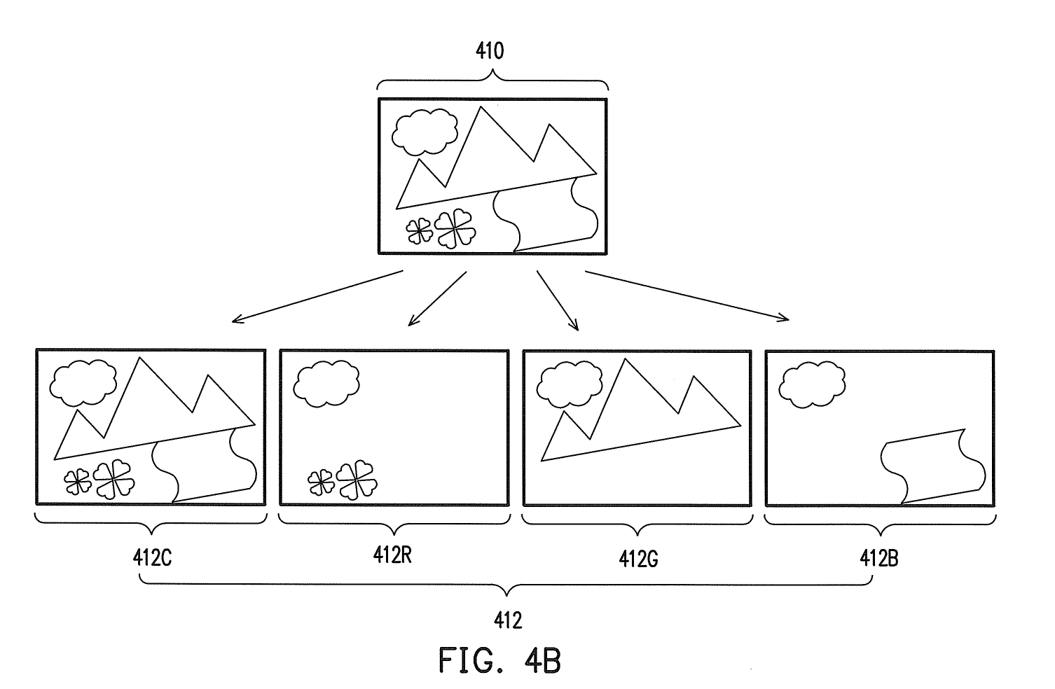

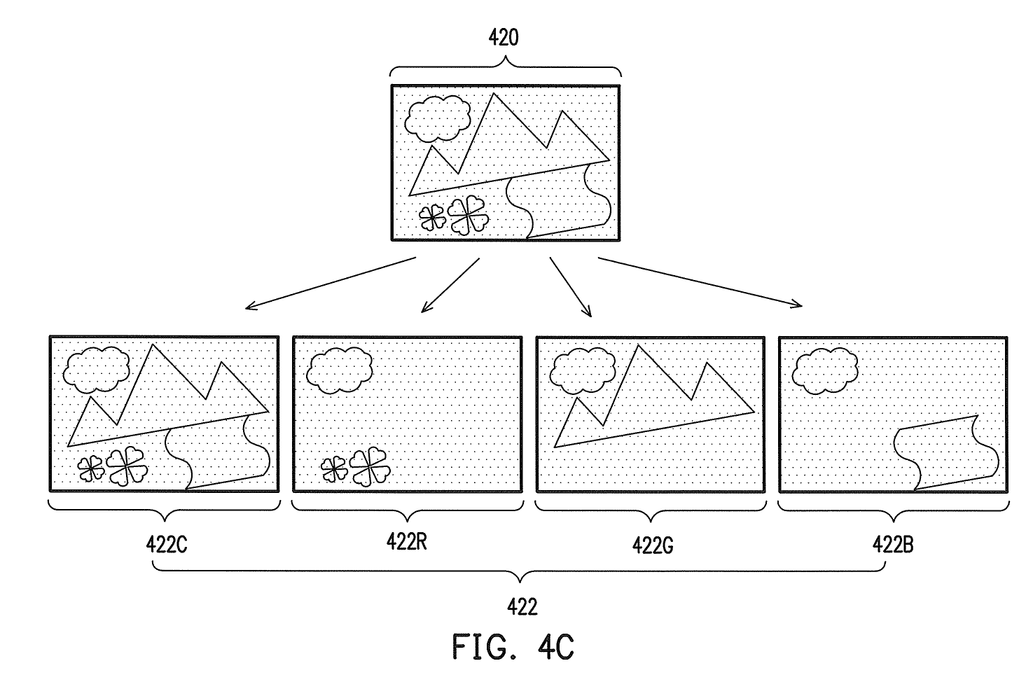

To give an example, as shown in FIG. 4A, the expected image 400 is assumed to include red flowers E_{R1} and E_{R2}, a green mountains E_{G}, a blue river E_{B}, a gray cloud E_{Gray}, and a black evening sky E_{Black}. The controller 130 of the present embodiment generates a backlight data 410 according to the red flowers E_{R1} and E_{R2}, the green mountains E_{G}, the blue river E_{B}, the gray cloud E_{Gray}, and the black evening sky E_{Black}. Moreover, the color distribution recorded in the backlight data 410 corresponds to the color distribution of the expected image 400. For example, red flowers E_{R1}, E_{R2}, B_{R1}, and B_{R2} are located at the left bottom corner of the expected image 400 and the backlight data 410 respectively. Green mountains E_{G} and B_{G} are located in the middle of the expected image 400 and the backlight data 410 respectively. Blue rivers E_{B} and B_{B} are located at the right bottom corner of the expected image 400 and the backlight data 410 respectively. Gray clouds E_{Gray} and B_{Gray} are located at the left top corner of the expected image 400 and the backlight data 410 respectively. Finally, black evening skies E_{Black} and B_{Black} are respectively located at the remaining locations of the expected image 400 and the backlight data 410.

Subsequently, the controller 130 generates a display data 420 according to the backlight data 410 and the expected image 400. In other words, red flowers D_{R1} and D_{R2}, a green mountains D_{G}, a blue river D_{B}, a gray cloud D_{Gray}, and a black evening sky D_{Black} that are recorded in the display data 420 are generated according to the red flowers B_{R1} and B_{R2}, the green mountains B_{G}, the blue river B_{B}, the gray cloud B_{Gray}, and the black evening sky B_{Black} that are recorded in the backlight data 410 and the red flowers E_{R1} and E_{R2}, the green mountains E_{G}, the blue river E_{B}, the gray cloud E_{Gray}, and the black evening sky E_{Black} shown in the expected image 400.

In the present embodiment, the controller 130 outputs the backlight data 410 and the display data 420 to the backlight module 110 and the display panel 120 respectively. However, in the following process, the controller 130 further determines a light-emitting pattern (described in the following) and a display pattern (described in the following) according to the backlight data 410 and the display data 420 respectively. As a result, the representation of the expected image 400 depends on the sampling of the backlight data 410 and the display data 420.

Take the red flowers E_{R1}, B_{R1}, and D_{R1} in the expected image 400, the backlight data 410, and the display data 420 as an example, in one embodiment, the accumulated effect of the light-emitting pattern and the display pattern respectively generated with the red flower B_{R1} and the red flower D_{R1} in the subsequent process substantially equals to the representation of the red flower E_{R1}. For example, the intensity of the light-emitting pattern generated with B_{R1} together with the intensity of the display pattern generated with D_{R1} substantially equal to the intensity of E_{R1}. The relationship between other images (i.e. E_{R2}, E_{G}, E_{B}, E_{Gray}, E_{Black}, and the like) in the expected image 400 and other information (i.e. B_{R2}, B_{G}, B_{B}, B_{Gray}, B_{Black}, and D_{R2}, D_{G}, D_{B}, D_{Gray}, D_{Black} and the like) recorded in the backlight data 410 and the display data 420 is inferred likewise.

As the color distribution recorded in the backlight data 410 corresponds to the color distribution of the expected image 400, the controller 130 of the present embodiment determines a light-emitting pattern 412 of the backlight module 110 according to the backlight data 410, as illustrated in FIG. 4A and FIG. 4B. Here, the color distribution of the light-emitting pattern 412 corresponds to the color distribution of the expected image 400 (step S303).

In the present embodiment, the light-emitting pattern 412 is constituted by a first color region 412C including red, green, and blue, a red second color region 412R, a green third color region 412G, and a blue fourth color region 412B. The red, green, and blue portions of the first color region 412C correspond to the red, green, and blue images of the expected image 400 respectively. The red second color region 412R corresponds to the red image of the expected image 400. The green third color region 412G corresponds to the green image of the expected image 400. In addition, the blue fourth color region 412B corresponds to the blue image of the expected image 400.

To give an example, referring to FIG. 4A and FIG. 4B simultaneously, based on the first color region 412C, the red portion thereof corresponds to the red flowers E_{R1}, E_{R2}, and the red portion of the gray cloud E_{Gray}. On the other hand, the green portion thereof corresponds to the green mountains E_{G} and the green portion of the gray cloud E_{Gray}. The blue portion thereof corresponds to the blue river E_{B} and the blue portion of the gray cloud E_{Gray}. Furthermore, the red second color region 412R corresponds to the red flowers E_{R1}, E_{R2}, and the red portion of the gray cloud E_{Gray}. The green third color region 412G corresponds to the green mountains E_{G} and the green portion of the gray cloud E_{Gray}. The blue fourth color region 412B corresponds to the blue river E_{B} and the blue portion of the gray cloud E_{Gray}.

In particular, the first color region 412C of the present embodiment is, for example, the summed result of the second, the third, and the fourth color regions 412R, 412G, and 412B. In other words, the red portion of the first color region 412C is substantially the red second color region 412R, the green portion of the first color region 412C is substantially the green third color region 412G, and the blue portion of the first color region 412C is substantially the blue fourth color region 412B.

Referring to FIG. 2 and FIG. 4B simultaneously, the second color region 412R is provided by at least a portion of the first color light-emitting units 110R (red light-emitting units), for example. The third color region 412G, for instance, is provided by at least a portion of the second color light-emitting units 110G (green light-emitting units). The fourth color region 412B, for example, is provided by at least a portion of the third color light-emitting units 110B (blue light-emitting units). Moreover, the first color region 412C is provided by at least a portion of the first color light-emitting units 110R (red light-emitting units), at least a portion of the second color light-emitting units 110G (green light-emitting units), and at least a portion of the third color light-emitting units 110B (blue light-emitting units). Here, the first color region 412C is deemed as the light-emitting effect generated as the first color light-emitting units 110R (red light-emitting units), the second color light-emitting units 110G (green light-emitting units), and the third color light-emitting units 110B (blue light-emitting units) respectively provide the second color region 412R, the third color region 412G, and the fourth color region 412B at the same time.

Therefore, the present embodiment locally controls the first, the second, and the third color light-emitting units 110R, 110G, and 110B. In addition, the light-emitting intensity of the first, the second, and the third color light-emitting units 110R, 110G, and 110B can be modified according to the gray-scale value of the expected image 400. For example, the first color light-emitting units 10R (red light-emitting units) allow the second color region 412R to obtain different light-emitting intensities base on the deep-red flower E_{R1} and the light-red flower E_{R2}. In another example, the evening sky (the black portion) is achieved by not-lightening the first, the second, and the third color light-emitting units 110R, 110G, and 110B (red, green, and blue light-emitting units).

Hence, the first, the second, the third, and the fourth color regions 412C, 412R, 412G, and 412B generated with the first, the second, and the third color light-emitting units 110R, 110G, and 110B can provide a gray-scale number of a certain level. Consequently, the backlight module 110 elevates the overall gray-scale number of the display image of the display apparatus 100, so as to enhance the contrast ratio and resolution of the display image. In one embodiment, the backlight module 110 provides a gray-scale number of at least 2 bits.

It should be noted that the backlight module 110 provides the first, the second, the third, and the fourth color regions 412C, 412R, 412G, and 412B for elevating the gray-scale number of the display image. Thus, although the display panel 120 of the present embodiment utilizes the passive LCD panel with less gray-scale number, the display apparatus 100 can still compensate the gray-scale number of the display image through the backlight module 110. Hence, the display apparatus 100 with the passive LCD panel not only has the advantages of low fabrication cost and low power consumption, but can also prevent the problem of insufficient gray-scale number in the conventional passive LCD apparatus.

In the following embodiment, the passive LCD panel is illustrated as an example. Herein, the passive LCD panel provides a gray-scale number of at least 6 bits. However, those skilled in the art can apply the LC layer 126 (i.e. STN LC) to provide a gray-scale number of at least 4 bits, and utilize the method of adjusting the gray-scale number with time control to further provide a gray-scale number of at least 2 bits.

As shown in FIG. 1, FIG. 4A, and FIG. 4C, the controller 130 of the present embodiment determines a display pattern 422 of the display panel 120 according to the display data 420 (step S305). In the present embodiment, the display panel 120 merely provides non-multicolored display images such as black, gray, and white. Moreover, the display pattern 422 is constituted by a first gray-scale pattern 422C, a second gray-scale pattern 422R, a third gray-scale pattern 422G, and a fourth gray-scale pattern 422B, for example. The first, the second, the third, and the fourth gray-scale patterns 422C, 422R, 422G, and 422B are respectively collocated with the first, the second, the third, and the fourth color regions 412C, 412R, 412G, and 412B aforementioned in the subsequent process to further display the image. However, in the present invention, the display panel 120 not only displays black, gray, and white images. In other embodiments, the display panel 120 also displays multicolored images.

To give an example, the backlight module 110 and the display panel 120 are assumed to provide gray-scale numbers of 2 bits and 6 bits respectively, so that the gray-scale number of the expected image 400 is 8 bits. That is, in the situation where the minimum to maximum gray-scale values of the expected image 400 are 0˜63, the red flowers D_{R1} and D_{R2}, the green mountains D_{G}, the blue river D_{B}, the gray cloud D_{Gray}, and the like that are recorded in the display data 420 are represented as red R0˜R63, green G0˜G63, and blue B0˜B63.

Take the gray cloud D_{Gray} as an example, if the gray-scale value representing the gray cloud D_{Gray} is (R60, G50, B20) in the display data 420, where the 60, 50, and 20 are respectively the first initial color gray-scale value, the second initial color gray-scale value, and the third initial color gray-scale value, then the minimum value 20 of the first, the second, and the third initial color gray-scale values 60, 50, and 20 is used as the specific gray-scale value. The gray-scale value representing the gray cloud D_{Gray} in the first sub-display data is set to be (R20, G20, B20) through this specific gray-scale value 20. Nevertheless, the specific gray-scale value is the minimum value of the first, the second, and the third initial color gray-scale values in the present embodiment, but the present invention is not limited thereto.

Furthermore, the first color gray-scale value 40 is obtained from the difference between the first initial color gray-scale value 60 and the specific gray-scale value 20. With this first color gray-scale value 40, the gray-scale value representing the gray cloud D_{Gray} in the second sub-display data is set to be (R40, G0, B0). Similarly, the second color gray-scale value 30 is obtained from the difference between the second initial color gray-scale value 50 and the specific gray-scale value 20. With this second color gray-scale value 30, the gray-scale value representing the gray cloud D_{Gray} in the third sub-display data is set to be (R0, G30, B0). The third color gray-scale value 0 is obtained from the difference between the third initial color gray-scale value 20 and the specific gray-scale value 20. With this third color gray-scale value 0, the gray-scale value representing the gray cloud D_{Gray} of the fourth sub-display data is set to be (R0, G0, B0).

Hence, the controller 130 determines the gray-scale patterns configured to represent the gray clouds in the first, the second, the third, and the fourth gray-scale patterns 422C, 422R, 422G, and 422B according to the gray-scale value (R20, G20, B20) configured to represent the gray cloud in the first sub-display data, the gray-scale value (R40, G0, B0) configured to represent the gray cloud in the second sub-display data, the gray-scale value (R0, G30, B0) configured to represent the gray cloud in the third sub-display data, and the gray-scale value (R0, G0, B0) configured to represent the gray cloud in the fourth sub-display data respectively. Here, the sum of the gray-scale values (R20, G20, B20), (R40, G0, B0), (R0, G30, B0), and (R0, G0, B0) that are configured to represent the gray clouds in the first, the second, the third, and the fourth sub-display data substantially equals to the gray-scale value (R60, G50, B20) configured to represent the gray cloud in the display data.

However, those skilled in the art should be able to determine other gray-scale patterns (i.e. the red flowers, the green mountains, the blue river, the black evening sky) with the first, the second, the third, and the fourth sub-display data. Thus, the method is not repeated herein. In short, the controller 130 of the present embodiment determines the first, the second, the third, and the fourth gray-scale patterns 422C, 422R, 422G, and 422B with the first, the second, the third, and the fourth sub-display data.

Subsequently, the display apparatus 100 displays the expected image 400 through the light-emitting pattern 412 provided by the backlight module 110 and the display pattern 422 provided by the display panel 120. The light-emitting pattern 412 has the first color region 412C, the second color region 412R, the third color region 412G, and the fourth color region 412B. On the other hand, the display pattern 422 has the first gray-scale pattern 422C, the second gray-scale pattern 422R, the third gray-scale pattern 422G, and the fourth gray-scale pattern 422B.

More specifically, in the present embodiment, the first color region 412C and the first gray-scale pattern 422C are provided simultaneously with the backlight module 110 and the display panel 120. The display apparatus 100 displays a first sub-image. Next, the second color region 412R and the second gray-scale pattern 422R are provided simultaneously with the backlight module 110 and the display panel 120. The display apparatus 100 displays a second sub-image. Thereafter, the third color region 412G and the third gray-scale pattern 422G are provided simultaneously with the backlight module 110 and the display panel 120. The display apparatus 100 displays a third sub-image. Then, the fourth color region 412B and the fourth gray-scale pattern 422B are provided simultaneously with the backlight module 110 and the display panel 120. The display apparatus 100 displays a fourth sub-image. Subsequently, the first, the second, and the third sub-images are displayed repetitively and consecutively. The display frequency of the first, the second, the third, and the fourth sub-images is approximately 240 Hz.

As illustrated in the foregoing, the display apparatus 100 of the present embodiment displays images by displaying the first sub-image, the second sub-image, the third sub-image, and the fourth sub-image sequentially and repetitively. It should be noted that in the present embodiment, by sequentially displaying the first sub-image constituted by the first color region and the first gray-scale pattern, the second sub-image constituted by the second color region and the second gray-scale pattern, the third sub-image constituted by the third color region and the third gray-scale pattern, and the fourth sub-image constituted by the fourth color region and the fourth gray-scale pattern, the color saturation and the contrast ratio of the display image are greatly enhanced. In addition, the color breakup (CBU) resulted from the conventional color sequential display apparatus is effectively improved.

### Second Embodiment

The concept to be illustrated in the present embodiment is similar to that of the first embodiment. The main difference between the two is that the light-emitting pattern and the display pattern of the present embodiment respectively simplify a color region and a gray-scale region so as to further simplify the driving method. However, the same or similar reference numbers in the present embodiment and the foregoing embodiment represent the same or similar elements. Accordingly, no further description thereof is provided hereinafter.

Referring to FIG. 1˜FIG. 3 and FIG. 4A, it must be illustrated that the controller 130 in the present embodiment also outputs the backlight data 410 and the display data 420 according to the color distribution of the expected image 400 (step S301), and determines the light-emitting pattern of the backlight module 110 and the display pattern of the display panel 120 according to the backlight data 410 and the display data 420, where the color distribution of the light-emitting pattern corresponds to the color distribution of the expected image 400 (steps S303 and S305). However, the illustration of this part can refer to FIG. 1˜FIG. 3 and FIG. 4A of the first embodiment and the descriptions thereof. In the following embodiment, the light-emitting pattern and the display pattern of the present embodiment and the relationship therebetween are mainly illustrated.

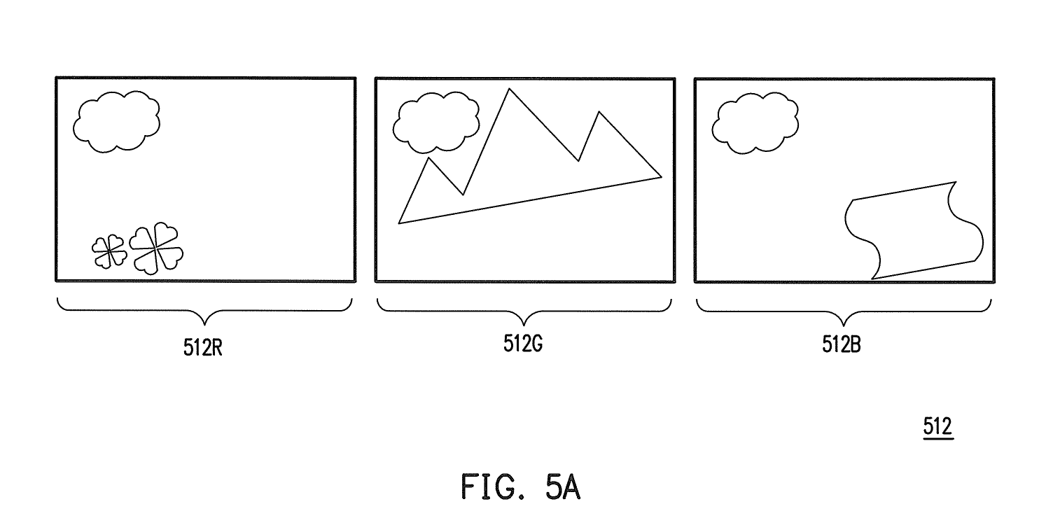

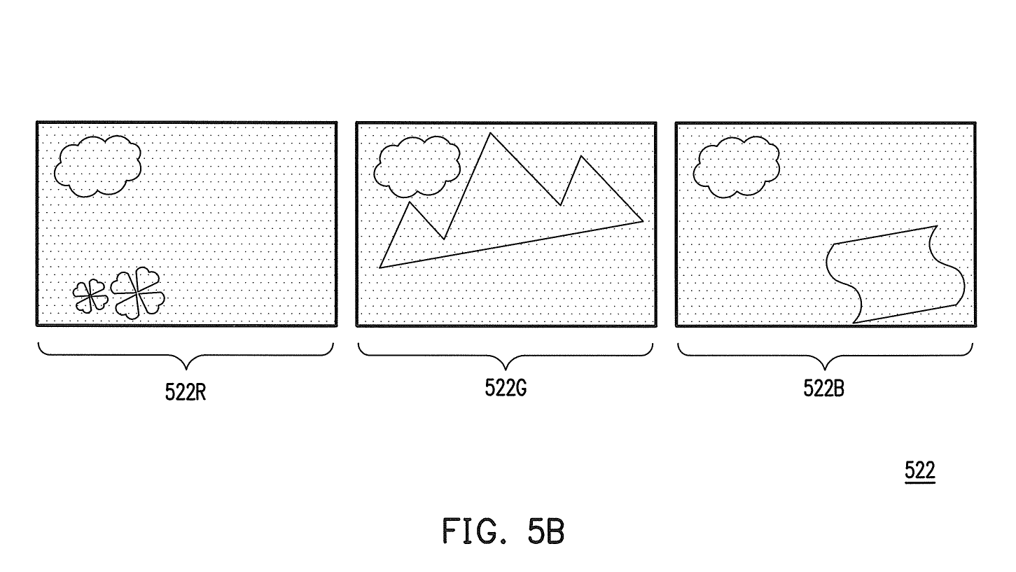

Referring to FIG. 5A, a light-emitting pattern 512 of the present embodiment is constituted by a red first color region 512R, a green second color region 512G, and a blue third color region 512B. The red first color region 512R corresponds to the red images of the expected image 400 (shown in FIG. 4A), such as the red flowers E_{R1}, E_{R2}, and the red portion of the gray cloud E_{Gray} in FIG. 4A. The green second color region 512G corresponds to the green images of the expected image 400, such as the mountains E_{G} and the green portion of the gray cloud E_{Gray} in FIG. 4A. The blue third color region 512B corresponds to the blue images of the expected image 400, such as the blue river E_{B} and the blue portion of the gray cloud E_{Gray} in FIG. 4A.

In the present embodiment, the first color region 512R is provided by at least a portion of the first color light-emitting units 110R (red light-emitting units), for example. The second color region 512G, for instance, is provided by at least a portion of the second color light-emitting units 110G (green light-emitting units). Moreover, the third color region 512B is provided by at least a portion of the third color light-emitting units 110B (blue light-emitting units), for example.

As illustrated in the foregoing, the present embodiment locally controls the first, the second, and the third color light-emitting units 110R, 110G, and 110B, so that the light-emitting intensities thereof vary in accordance with the color distribution of the expected image 400. For example, the first color light-emitting units 110R (red light-emitting units) allow the first color region 512R to obtain different light-emitting intensities according to the deep-red flower E_{R1} and the light-red flower E_{R2}. In another example, the evening sky (the black portion) is achieved by not-lightening the first, the second, and the third color light-emitting units 110R, 110G, and 110B (red, green, and blue light-emitting units).

Hence, the first, the second, and the third color regions 512R, 512G, and 512B generated with the first, the second, and the third color light-emitting units 110R, 110G, and 110B provide a gray-scale number of a certain level. Consequently, the backlight module 110 elevates the overall gray-scale number of the display image of the display apparatus 100, so as to enhance the contrast ratio and resolution of the display image and reduce the power consumption of the display apparatus 100. In one embodiment, the backlight module 110 provides a gray-scale number of at least 2 bits.

Since the backlight module 110 provides the first, the second, and the third color regions 512R, 512G, and 512B for elevating the gray-scale number of the display image, although the display panel 120 of the present embodiment applies the passive LCD panel with less gray-scale number, the display apparatus 100 can still compensate the gray-scale number of the display image through the backlight module 110. Consequently, the display apparatus 100 with the passive LCD panel has the advantages of low fabrication cost and low power consumption. Additionally, the problem of insufficient gray-scale number in the conventional passive LCD apparatus is also prevented.

On the other hand, as illustrated in FIG. 5B, a display pattern 522 of the present embodiment is constituted by a first gray-scale pattern 522R, a second gray-scale pattern 522G, and a third gray-scale pattern 522B, for example. The first, the second, and the third gray-scale patterns 522R, 522G, and 522B are non-colored gray-scale images, for instance. In the subsequent process the first, the second, and the third gray-scale patterns 522R, 522G, and 522B are respectively collocated with the first, the second, and the third color regions 512R, 512G, and 512B to further display the image.

In the following embodiment, the passive LCD panel is illustrated as an example. Herein, the passive LCD panel provides a gray-scale number of at least 6 bits. However, those skilled in the art can apply the LC layer 126 (i.e. STN LC) to provide a gray-scale number of at least 4 bits, and utilize the method of adjusting the gray-scale number with time control to further provide a gray-scale number of at least 2 bits, so that the passive LCD panel has a gray-scale number of at least 6 bits.

Referring to FIG. 1 and FIG. 4A simultaneously, as aforementioned, the backlight module 110 and the display panel 120 are assumed to provide gray-scale numbers of 2 bits and 6 bits respectively, so that the gray-scale number of the expected image 400 is 8 bits. That is, in the situation where the minimum to maximum gray-scale values of the expected image 400 are 0˜63, the red flowers D_{R1} and D_{R2}, the green mountains D_{G}, the blue river D_{B}, the gray cloud D_{Gray}, and the like that are recorded in the display data 420 are represented as red R0˜R63, green G0˜G63, and blue B0˜B63.

Take the gray cloud D_{Gray} as an example, the gray-scale value representing the gray cloud D_{Gray} is (R60, G50, B20) in the display data 420, where the 60, 50, and 20 are respectively the first color gray-scale value, the second color gray-scale value, and the third color gray-scale value. In the present embodiment, the first color gray-scale value is used to set the gray-scale value representing the gray cloud D_{Gray} in the first sub-display data to be (R60, G0, B0). The second color gray-scale value is used to set the gray-scale value representing the gray cloud D_{Gray} in the second sub-display data to be (R0, G50, B0). Moreover, the third color gray-scale value is used to set the gray-scale value representing the gray cloud D_{Gray} in the third sub-display data to be (R0, G0, B20).

Hence, the controller 130 determines the gray-scale patterns configured to represent the gray clouds in the first, the second, and the third gray-scale patterns 522R, 522G, and 522B according to the gray-scale value (R60, G0, B0) configured to represent the gray cloud in the first sub-display data, the gray-scale value (R0, G50, B0) configured to represent the gray cloud in the second sub-display data, and the gray-scale value (R0, G0, B20) configured to represent the gray cloud in the third sub-display data respectively. Here, the sum of the gray-scale values (R60, G0, B0), (R0, G50, B0), and (R0, G0, B20) that are configured to represent the gray clouds in the first, the second, and the third sub-display data substantially equals to the gray-scale value (R60, G50, B20) configured to represent the gray cloud in the display data.

However, those skilled in the art should be able to determine other gray-scale patterns (i.e. the red flowers, the green mountains, the blue river, the black evening sky) with the first, the second, and the third sub-display data. Thus, the method is not repeated herein. In short, the controller 130 of the present embodiment determines the first, the second, and the third gray-scale patterns 522R, 522G, and 522B with the first, the second, and the third sub-display data.

Next, the display apparatus 100 displays the expected image 400 through the light-emitting pattern 512 provided by the backlight module 110 and the display pattern 522 provided by the display panel 120. The light-emitting pattern 512 has the first color region 512R, the second color region 512G, and the third color region 512B. On the other hand, the display pattern 522 has the first gray-scale pattern 522R, the second gray-scale pattern 522G, and the third gray-scale pattern 522B.

Referring to FIG. 5A and FIG. 5B simultaneously, in the present embodiment, the first color region 512R and the first gray-scale pattern 522R are provided simultaneously with the backlight module 110 and the display panel 120. The display apparatus 100 displays a first sub-image. Thereafter, the second color region 512G and the second gray-scale pattern 522G are provided simultaneously with the backlight module 110 and the display panel 120. The display apparatus 100 displays a second sub-image. Then, the third color region 512B and the third gray-scale pattern 522B are provided simultaneously with the backlight module 110 and the display panel 120. The display apparatus 100 displays a third sub-image. Subsequently, the first, the second, and the third sub-images are displayed repetitively and consecutively. The display frequency of the first, the second, and the third sub-images is approximately 180 Hz.

As illustrated in the foregoing, the display apparatus 100 of the present embodiment displays images by displaying the first sub-image, the second sub-image, and the third sub-image sequentially and repetitively. It should be noted that in the present embodiment, by sequentially displaying the first sub-image constituted by the first color region and the first gray-scale pattern, the second sub-image constituted by the second color region and the second gray-scale pattern, and the third sub-image constituted by the third color region and the third gray-scale pattern, the color saturation and the contrast ratio of the display image are greatly enhanced. In addition, the CBU of the display image resulted from the conventional color sequential display apparatus is improved.

### Third Embodiment

The concept to be illustrated in the present embodiment is similar to that of the foregoing embodiment. The main difference between the two is that the light-emitting pattern and the display pattern of the present embodiment are simplified to a multicolored region and a multicolored pattern respectively. However, the same or similar reference numbers in the present embodiment and the foregoing embodiment represent the same or similar elements. Accordingly, no further description thereof is provided hereinafter.

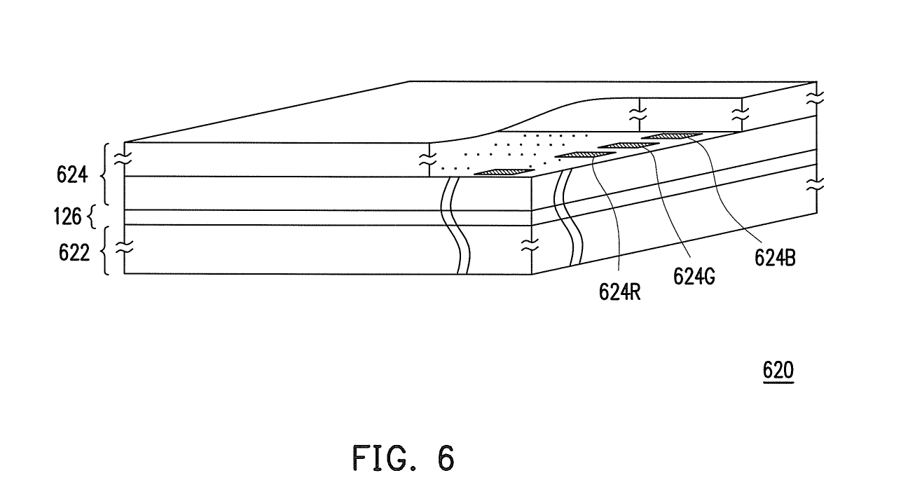

Referring to FIG. 6, FIG. 6 is a partial cross-sectional view of a display panel according to a third embodiment of the present invention. A display panel 620 of the present embodiment includes a pixel array substrate 622, a color filter 624, and an LC layer 126 clamped between the pixel array substrate 622 and the color filter 624. The pixel array substrate 622 is, for example, a passive array substrate. The color filter 624 includes a plurality of color filter patterns 624R, 624G, and 624B. The LC layer 126 is an STN LC layer, for instance.

Obviously, in other embodiments, the pixel array substrate 622 is also an active device array substrate or a display panel of other types. In other words, the present invention does not limit the type of the display panel 620. In addition, the display panel 620 of the present embodiment further includes other components, and FIG. 6 omits the other components mainly to facilitate the illustration of the following embodiment.

Referring to FIG. 1˜FIG. 3, FIG. 4A, and FIG. 6 simultaneously, the controller 130 in the present embodiment also outputs the backlight data 410 and the display data 420 according to the color distribution of the expected image 400 (step S301), and determines the light-emitting pattern of the backlight module 110 and the display pattern of the display panel 620 according to the backlight data 410 and the display data 420, where the color distribution of the light-emitting pattern corresponds to the color distribution of the expected image 400 (steps S303 and S305). However, the illustration of this part can refer to FIG. 1˜FIG. 3 and FIG. 4A of the first embodiment and the descriptions thereof. In the following embodiment, the light-emitting pattern and the display pattern of the present embodiment and the relationship therebetween are mainly illustrated.

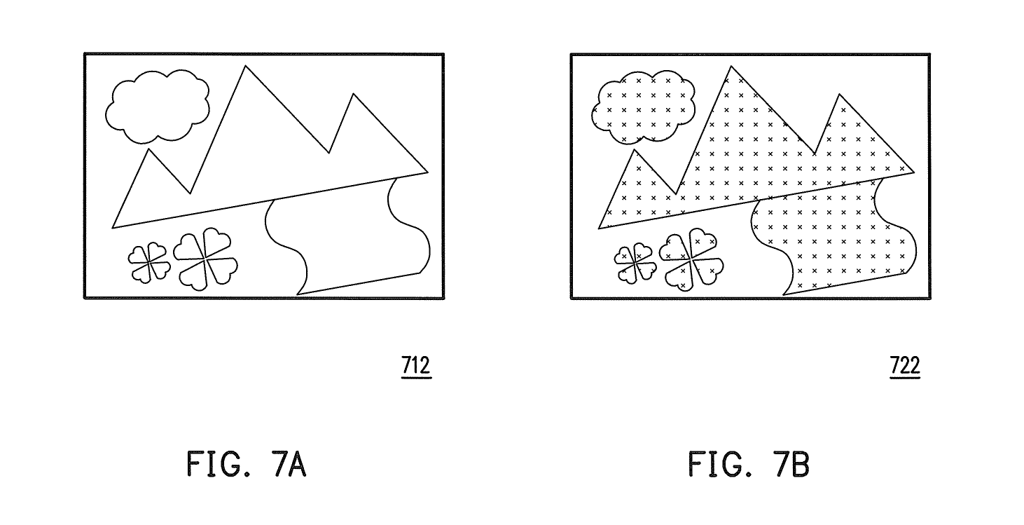

Referring to FIG. 6, FIG. 7A, and FIG. 7B simultaneously, specifically, the controller 130 (shown in FIG. 1) of the present embodiment determines a light-emitting pattern 712 and a display pattern 722 according to the backlight data 410 and the display data 420 (shown in FIG. 4A) respectively. In the present embodiment, the display panel 620 makes the display pattern 722 to be a multicolored pattern through the disposition of the color filter 624. The color distribution of the multicolored pattern corresponds to the color distribution of the expected image 400.

Moreover, the light-emitting pattern 712 of the present embodiment is a multicolored region, and the color distribution of the multicolored region corresponds to the color distribution of the expected image 400. Here, the multicolored region is provided by at least a portion of the first color light-emitting units 110R (red light-emitting units), at least a portion of the second color light-emitting units 110G (green light-emitting units), and at least a portion of the third color light-emitting units 110B (blue light-emitting units) of the backlight module 110 (shown in FIG. 2).

As aforementioned, the backlight module 110 in the display apparatus 100 of the present embodiment provides multicolored light-emitting patterns, and the display panel 120 thereof also provides multicolored display patterns. Thus, the color saturation and the contrast ratio of the display image of the display apparatus 100 are greatly enhanced.

Furthermore, as the first, the second, and the third color light-emitting units 110R, 110G, and 110B are locally controlled, the light intensities thereof vary in accordance with the color distribution of the expected image 400. For example, the first color light-emitting units 110R (red light-emitting units) allow the light-emitting pattern 712 (multicolored region) to obtain different light-emitting intensities according to the deep-red flower E_{R1} and the light-red flower E_{R2} in FIG. 4A. In another example, the evening sky (the black portion) is achieved by not-lightening the first, the second, and the third color light-emitting units 110R, 110G, and 110B (red, green, and blue light-emitting units).

Hence, the backlight module 110 of the present embodiment provides a gray-scale number of a certain level through the light-emitting pattern 712 (multicolored region), which is generated by the first, the second, and the third color light-emitting units 110R, 110G, and 110B. The backlight module 110 therefore elevates the overall gray-scale number of the display image of the display apparatus 100. In one embodiment, the backlight module 110 provides a gray-scale number of at least 2 bits.

It should be noted that the backlight module 110 provides the light-emitting pattern 712 (multicolored region) which is configured to elevate the gray-scale number of the display image. Therefore, in term of the passive LCD panel with the passive array substrate, the light-emitting pattern 712 of the backlight module 110 of the present embodiment compensates the problem of insufficient gray-scale number in passive LCD panels. More specifically, in the present embodiment, the display apparatus 100 applying the passive LCD panel not only has the advantages of low fabrication cost and low power consumption, but the display image thereof also has good display quality.

As illustrated in the foregoing, in the three embodiments above-mentioned, the backlight module in the display apparatus is collocated with display panels of multiple types, such as a conventional display panel with color filter, a display panel with color filter-less design, a passive LCD panel, an active LCD panel, and the like. Take the display apparatus having the passive LCD panel as an example, this display apparatus has the advantages of low power consumption, fabrication cost and time reduction. Take the display apparatus with the color filter-less design as an example, this display apparatus is driven through the color sequential method of displaying sub-images sequentially, so as to improve the CBU phenomenon. In short, both the display apparatus and the driving method thereof of the foregoing embodiment enhance the display quality.

In summary, the display apparatus and the driving method thereof enhance the display quality. The backlight module of the display apparatus provides the light-emitting pattern that corresponds to the color distribution of the expected image, and the backlight module is collocated with display panels of multiple types. Overall, the present invention has advantages of elevating color saturation, contrast ratio, gray-scale number of the display image, and resolution, and reducing power consumption.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving method, adapted to drive a backlight module and a display panel thereon, the driving method comprising:
outputting a backlight data and a display data according to a color distribution of an expected image;
determining a light-emitting pattern of the backlight module according to the backlight data, wherein a color distribution of the light-emitting pattern corresponds to the color distribution of the expected image; and
determining a display pattern of the display panel according to the display data.

2. The driving method as claimed in claim 1, wherein the outputting of the display data comprises:
outputting the backlight data according to the color distribution of the expected image; and
outputting the display data according to the color distribution of the expected image and the backlight data.

3. The driving method as claimed in claim 1, wherein the light-emitting pattern has a first color region, a second color region, a third color region, and a fourth color region, and color distributions of the first color region, the second color region, the third color region, and the fourth color region correspond to the color distribution of the expected image.

4. The driving method as claimed in claim 3, wherein the display data has a first sub-display data recording a specific gray-scale value, a second sub-display data recording a first color gray-scale value, a third sub-display data recording a second color gray-scale value, and a fourth sub-display data recording a third color gray-scale value, and the display pattern has a first gray-scale pattern, a second gray-scale pattern, a third gray-scale pattern, and a fourth gray-scale pattern.

5. The driving method as claimed in claim 4, wherein a first initial color gray-scale value, a second initial color gray-scale value, and a third initial color gray-scale value are recorded in the display data, the specific gray-scale value is a minimum value of the first initial color gray-scale value, the second initial color gray-scale value, and the third initial color gray-scale value, and the first color gray-scale value is a difference between the first initial color gray-scale value and the specific gray-scale value, the second color gray-scale value is a difference between the second initial color gray-scale value and the specific gray-scale value, and the third color gray-scale value is a difference between the third initial color gray-scale value and the specific gray-scale value.

6. The driving method as claimed in claim 4, wherein the determining of the display pattern of the display panel comprises:
determining the first gray-scale pattern according to the first sub-display data;
determining the second gray-scale pattern according to the second sub-display data;
determining the third gray-scale pattern according to the third sub-display data; and
determining the fourth gray-scale pattern according to the fourth sub-display data.

7. The driving method as claimed in claim 4, wherein the expected image has a first sub-image, a second sub-image, a third sub-image, and a fourth sub-image, and the displaying of the expected image comprises:
displaying the first sub-image according to the first color region and the first gray-scale pattern;
displaying the second sub-image according to the second color region and the second gray-scale pattern;
displaying the third sub-image according to the third color region and the third gray-scale pattern; and
displaying the fourth sub-image according to the fourth color region and the fourth gray-scale pattern,
wherein the first sub-image, the second sub-image, the third sub-image, and the fourth sub-image are displayed sequentially.

8. The driving method as claimed in claim 7, wherein a color of the first color region comprises red, green, and blue, the second color region is a red region, the third color region is a green region, and the fourth color region is a blue region.

9. The driving method as claimed in claim 1, wherein the light-emitting pattern has a first color region, a second color region, and a third color region, and color distributions of the first color region, the second color region, and the third color region correspond to the color distribution of the expected image.

10. The driving method as claimed in claim 9, wherein the display data has a first sub-display data recording a first color gray-scale value, a second sub-display data recording a second color gray-scale value, and a third sub-display data recording a third color gray-scale value, and the display pattern has a first gray-scale pattern, a second gray-scale pattern, and a third gray-scale pattern.

11. The driving method as claimed in claim 10, wherein the determining of the display pattern of the display panel comprises:
determining the first gray-scale pattern according to the first sub-display data;
determining the second gray-scale pattern according to the second sub-display data; and
determining the third gray-scale pattern according to the third sub-display data.

12. The driving method as claimed in claim 10, wherein the expected image has a first sub-image, a second sub-image, and a third sub-image, and the displaying of the expected image comprises:
displaying the first sub-image according to the first color region and the first gray-scale pattern;
displaying the second sub-image according to the second color region and the second gray-scale pattern; and
displaying the third sub-image according to the third color region and the third gray-scale pattern,
wherein the first sub-image, the second sub-image, and the third sub-image are displayed sequentially.

13. The driving method as claimed in claim 1, wherein the light-emitting pattern and the display pattern are a multicolored region and a multicolored pattern respectively, a color distribution of the multicolored region and a color distribution of the multicolored pattern correspond to the color distribution of the expected image respectively.

14. A display apparatus, comprising:
a backlight module;
a display panel, disposed on the backlight module; and
a controller, coupled to the backlight module and the display panel, outputting a backlight data and a display data to the backlight module and the display panel respectively according to a color distribution of an expected image, and determining a light-emitting pattern of the backlight module and a display pattern of the display panel according to the backlight data and the display data respectively, wherein a color distribution of the light-emitting pattern corresponds to the color distribution of the expected image.

15. The display apparatus as claimed in claim 14, wherein the controller generates and outputs the backlight data according to the color distribution of the expected image, and generates and outputs the display data according to the color distribution of the expected image and the backlight data.

16. The display apparatus as claimed in claim 14, wherein the display panel comprises a passive liquid crystal display panel.

17. The display apparatus as claimed in claim 14, wherein the light-emitting pattern has a first color region, a second color region, a third color region, and a fourth color region, and color distributions of the first color region, the second color region, the third color region, and the fourth color region correspond to the color distribution of the expected image.

18. The display apparatus as claimed in claim 17, wherein the backlight module comprises a plurality of first color light-emitting units, a plurality of second color light-emitting units, and a plurality of third color light-emitting units, at least a portion of the first color light-emitting units, at least a portion of the second color light-emitting units, and at least a portion of the third color light-emitting units provide the first color region, at least a portion of the first color light-emitting units provides the second color region, at least a portion of the second color light-emitting units provides the third color region, and at least a portion of the third color light-emitting units provides the fourth color region.

19. The display apparatus as claimed in claim 17, wherein the display data has a first sub-display data recording a specific gray-scale value, a second sub-display data recording a first color gray-scale value, a third sub-display data recording a second color gray-scale value, and a fourth sub-display data recording a third color gray-scale value, and the display pattern has a first gray-scale pattern, a second gray-scale pattern, a third gray-scale pattern, and a fourth gray-scale pattern.

20. The display apparatus as claimed in claim 19, wherein a first initial color gray-scale value, a second initial color gray-scale value, and a third initial color gray-scale value are recorded in the display data, the specific gray-scale value is a minimum value of the first initial color gray-scale value, the second initial color gray-scale value, and the third initial color gray-scale value, and the first color gray-scale value is a difference between the first initial color gray-scale value and the specific gray-scale value, the second color gray-scale value is a difference between the second initial color gray-scale value and the specific gray-scale value, and the third color gray-scale value is a difference between the third initial color gray-scale value and the specific gray-scale value.

21. The display apparatus as claimed in claim 19, wherein the controller determines the first gray-scale pattern, the second gray-scale pattern, the third gray-scale pattern, and the fourth gray-scale pattern according to the first sub-display data, the second sub-display data, the third sub-display data, and the fourth sub-display data respectively.

22. The display apparatus as claimed in claim 19, wherein the expected image has a first sub-image, a second sub-image, a third sub-image, and a fourth sub-image,
wherein the display apparatus displays the first sub-image according to the first color region and the first gray-scale pattern, the second sub-image according to the second color region and the second gray-scale pattern, the third sub-image according to the third color region and the third gray-scale pattern, and the fourth sub-image according to the fourth color region and the fourth gray-scale pattern, and the first sub-image, the second sub-image, the third sub-image, and the fourth sub-image are displayed sequentially.

23. The display apparatus as claimed in claim 22, wherein a color of the first color region comprises red, green, and blue, the second color region is a red region, the third color region is a green region, and the fourth color region is a blue region.

24. The display apparatus as claimed in claim 14, wherein the light-emitting pattern has a first color region, a second color region, and a third color region, and color distributions of the first color region, the second color region, and the third color region correspond to the color distribution of the expected image.

25. The display apparatus as claimed in claim 24, wherein the backlight module comprises a plurality of first color light-emitting units, a plurality of second color light-emitting units, and a plurality of third color light-emitting units, and at least a portion of the first color light-emitting units provides the first color region, at least a portion of the second color light-emitting units provides the second color region, and at least a portion of the third color light-emitting units provides the third color region.

26. The display apparatus as claimed in claim 24, wherein the display data has a first sub-display data recording a first color gray-scale value, a second sub-display data recording a second color gray-scale value, and a third sub-display data recording a third color gray-scale value, and the display pattern has a first gray-scale pattern, a second gray-scale pattern, and a third gray-scale pattern.

27. The display apparatus as claimed in claim 26, wherein the controller determines the first gray-scale pattern, the second gray-scale pattern, and the third gray-scale pattern according to the first sub-display data, the second sub-display data, and the third sub-display data respectively.

28. The display apparatus as claimed in claim 26, wherein the expected image has a first sub-image, a second sub-image, and a third sub-image,
wherein the display apparatus displays the first sub-image according to the first color region and the first gray-scale pattern, the second sub-image according to the second color region and the second gray-scale pattern, and the third sub-image according to the third color region and the third gray-scale pattern, and the first sub-image, the second sub-image, and the third sub-image are displayed sequentially.

29. The display apparatus as claimed in claim 14, wherein the light-emitting pattern and the display pattern are a multicolored region and a multicolored pattern respectively, a color distribution of the multicolored region and a color distribution of the multicolored pattern correspond to the color distribution of the expected image respectively.

30. The display apparatus as claimed in claim 29, wherein the backlight module comprises a plurality of first color light-emitting units, a plurality of second color light-emitting units, and a plurality of third color light-emitting units, and at least a portion of the first color light-emitting units, at least a portion of the second color light-emitting units, and at least a portion of the third color light-emitting units provide the multicolored region, and the display panel comprises a color filter.
